(19) United States
(12) Patent Application Publication
(10) Pub. No.: US 2017/0354962 A1
(43) Pub. Date: Dec. 14, 2017

(54) SYNTHESIS OF TRIMETALLIC NANOPARTICLES BY HOMOGENEOUS DEPOSITION PRECIPITATION, AND APPLICATION OF THE SUPPORTED CATALYST FOR CARBON DIOXIDE REFORMING OF METHANE

(71) Applicant: SABIC GLOBAL TECHNOLOGIES B.V., Bergen op Zoom (NL)

(72) Inventors: Lawrence D'Souza, Thuwal (SA); Kazuhiro Takanabe, Thuwal (SA); Paco Laveille, Thuwal (SA); Bedour Al Sabban, Thuwal (SA); Jean-Marie Basset, Thuwal (SA); Lidong Li, Thuwal (SA)

(21) Appl. No.: 15/527,149

(22) PCT Filed: Nov. 19, 2015
(86) PCT No.: PCT/IB2015/058968

§ 371 Date: May 16, 2017

Related U.S. Application Data
(60) Provisional application No. 62/207,666, filed on Aug. 20, 2015.
(60) Provisional application No. 62/085,780, filed on Dec. 1, 2014.

(51) Int. Cl. B01J 35/00; B01J 37/02; C01B 3/40; B01J 23/89

(52) U.S. Cl. CPC B01J 35/0093; B01J 23/8953; B01J 23/89; B01J 37/0203; B01J 35/006; B01J 23/8986; C01B 3/40; C01B 2203/1082; C01B 2203/1047

(57) ABSTRACT

Disclosed is a supported nanoparticle catalyst, methods of making the supported nanoparticle 5 catalysts and uses thereof. The supported nanoparticle catalyst includes catalytic metals M1, M2, M3, and a support material. M1 and M2 are different and are each selected from nickel (Ni), cobalt (Co), manganese (Mn), iron (Fe), copper (Cu) or zinc (Zn), wherein M1 and M2 are dispersed in the support material. M3 is a noble metal deposited on the surface of the nanoparticle catalyst and/or dispersed in the support material. The nanoparticle catalyst is 10 capable of producing hydrogen (H2) and carbon monoxide (CO) from methane (CH4) and carbon dioxide (CO2).

### CROSS REFERENCE TO RELATED APPLICATIONS

This application claims the benefit of priority of U.S. Provisional Patent Application No. 62/085,780 filed Dec. 1, 2014, and U.S. Provisional Patent Application No. 62/207,666 filed Aug. 20, 2015. The entire contents of each of the above-referenced disclosures are specifically incorporated herein by reference without disclaimer.

### BACKGROUND OF THE INVENTION

### A. Field of the Invention

The invention generally concerns a nanoparticle catalyst and uses thereof in the reforming of methane. In particular, the invention concerns a nanoparticle catalyst that includes catalytic metals M¹, M², M³, and a support material. M¹ and M² are different and are each selected from (Ni), cobalt (Co), manganese (Mn), iron (Fe), copper (Cu) or zinc (Zn). M¹ and M² are dispersed in the support material and M³ is a noble metal deposited on the surface of the nanoparticle catalyst and/or dispersed in the support material.

### B. Description of Related Art

Synthesis gas (“syngas”) includes carbon monoxide (CO), hydrogen (H₂), and, in some instances, carbon dioxide (CO₂). Syngas can be produced through steam reforming of methane (CH₄) as shown in reaction Equation 1.

CH₄+H₂O→2H₂+CO (1)

Syngas can also be produced by carbon dioxide (CO₂) reforming of methane, which is also referred to as dry reforming of methane as shown in reaction Equation 2.

CH₄+CO₂→2H₂+2CO (2)

CO₂ is a known greenhouse gas and methods to utilize it as a resource to produce more valuable compounds are highly attractive. Dry reforming of methane can produce hydrogen and carbon monoxide at lower H₂/CO ratios than steam reforming of methane, thereby making it an attractive process for subsequent Fischer-Tropsch synthesis of long chain hydrocarbons and methanol synthesis, etc. However, dry reforming of methane suffers from a high thermodynamic requirement (high endothermicity), and can require high temperatures (800-900° C.) to achieve high conversion, which in turn can cause formation of solid carbon (e.g., coke). Commercial catalysts can be used lower the activation energy of the reaction, thereby lowering the temperature, which in turn, can coke formation and oxidation of carbon compounds. For example, many commercial catalysts for steam and dry reforming of methane include nickel (Ni) to lower the activation energy of the reforming reaction. Nickel, however, is susceptible to deactivation at high temperatures due to coke formation and sintering of metal nanoparticles. Removal of carbon species from the surface of nickel catalyst can be difficult or nonexistent, leading to filamentous carbon formation, which may not cause deactivation, but can lead to blocking the catalyst bed and ultimately destruction of the catalyst particles. To control filamentous carbon formation, nickel catalysts can be doped with noble metals, however, these catalysts suffer in that the produced coke can encapsulate the metal surfaces, which in turn deactivates the catalyst. Attempts to control the activity towards methane decomposition using combinations of metals in the catalyst have been reported. For example, partial substitution of nickel with cobalt has been reported to provide high stability with low carbon content. However, such NiCo catalysts suffer in that they have low conversion performance and stability due to the cobalt oxidation under dry reforming conditions. As previously stated, high temperature operations can also lead to metal sintering, which causes the loss of catalyst's surface atoms (dispersion), thereby decreasing available active sites for catalysis. Metal sintering is the agglomeration of small metal nanoparticles into larger ones through the metal's crystallite and atom migration on the surface of the support. Because particle size of the metal can correlate with coking, sintering of metal particles can also cause deactivation of catalysts over time.

Attempts to inhibit carbonaceous species from depositing on the catalyst have included the use of metal oxides as a support material for catalysts. For example, reducible metal oxides that are capable of storing and releasing active oxygen species during the reaction have been reported to improve coke oxidation and increase catalyst lifetime. Non-inert metal oxides can also provide adsorption sites for CO₂ and H₂O, which then can react with the reactive species derived from dissociative chemisorption of methane on supported metallic phases. However, catalysts made with such supports also suffer from metal sintering and coke formation at low temperatures. Furthermore, coke formation can be attributed to catalysts where the metal-support interactions are minimal.

### SUMMARY OF THE INVENTION

A solution to the above problems associated with catalysts for reforming of methane has been discovered. In particular, the catalysts can be used at the higher temperatures required for dry reforming of methane. The solution lies in a supported nanoparticle catalyst that includes at least three catalytic metals and a support. The catalyst integrates the nature of metal, the support, and the resulting metal-support interaction to provide an elegant way to control and reduce sintering of supported metal catalyst under methane reforming conditions. Two of the three catalytic metals are catalytic transition metals that are homogeneously dispersed in the support and form a core of the catalyst. The third catalytic metal, which is a noble metal, can be deposited on the surface of the nanoparticle catalyst. In some instance, all three metals can be homogenously dispersed throughout the support as particles or metal alloys. The support can have properties that allow it to store and release active oxygen species during the reaction. Without wishing to be bound by theory it is believed that alloying of the catalytic transition metals and the inclusion of a noble metal on a support, avoids coke formation due to the high oxidative properties of transition metal and the support, which can oxidize carbonaceous species as soon as they are formed from methane decomposition. Inclusion of the noble metal avoids inactivation of the catalyst by progressive oxidation of the transition metals. By way of example, dispersion of nickel-cobalt alloy nanoparticles in a zirconia support and the inclusion of Pt on the surface of the supported nanoparticles, can avoid coke formation and deactivation of the catalyst over extended periods of time. Without wishing to be bound by theory, it is believed that coke formation is avoided due the high oxidative properties of cobalt and zirconia, which can oxidize carbonaceous species as soon as they are formed from methane decomposition on the surface of the catalyst. It is also believed that the inclusion of Pt avoids inactivation of the catalyst by progressive oxidation of the Ni and Co. Thus, the catalysts of the present invention provide supported nanoparticle catalysts that are highly resistant against coke formation and sintering in the reforming of methane (e.g., carbon dioxide reforming, steam reforming and partial oxidation of methane) processes.

In one aspect of the present invention, a nanoparticle catalyst having catalytic metals M¹, M², M³, and a support material is described. Catalytic metals, M¹ and M², are different and are dispersed in the support material. M¹ and M² can be nickel (Ni), cobalt (Co), manganese (Mn), iron (Fe), copper (Cu) or zinc (Zn). M¹ and M² can be metal particles or a metal alloy (M¹M²) that is dispersed, preferably homogeneously, throughout the support. M¹ can be 25 to 75 molar % of the total moles of catalytic metals (M¹,M²,M³), M² can be 25 to 75 molar % of the total moles of catalytic metals (M¹,M²,M³). The third catalytic metal, M³ is a noble metal (e.g., platinum (Pt), rhodium (Rh), ruthenium (Ru), iridium (Ir), silver (Ag), gold (Au) or palladium (Pd)) that can be deposited on the surface of the nanoparticle catalyst and/or dispersed in the support material. M³ can be 0.01 to 0.2 molar % of the total moles of catalytic metals (M¹,M²,M³). When M³ is dispersed throughout the support, it can be dispersed as metal particles or as part of a metal alloy that contains the catalytic metal (e.g., M¹M²M³). The support include a metal oxide (e.g., ZrO₂, ZnO, Al₂O₃, CeO₂, TiO₂, MgAl₂O₄, SiO₂, MgO, CaO, BaO, SrO, V₂O₅, Cr₂O₃, Nb₂O₅, WO₃, or any combination thereof), a mixed metal oxide, a metal sulfide, a chalcogenide, an oxide of spinel, an oxide of wuestite structure (FeO), an oxide of olivine clay, an oxide of perovskite, a zeolite, carbon black, graphitic carbon, or a carbon nitride. The support can be 80 to 99.5 wt. % of supported nanoparticle catalyst. The average particle size of the nanoparticle catalyst is about 1 to 100 nm, preferably 1 to 30 nm, more preferably 3 to 15 nm, most preferably less than or equal (≦) to 10 with a size distribution having a standard deviation of ±20%. In a particular aspect, M¹ is Ni, M² is Co, M³ is Pt, and the support is ZrO₂. The catalyst or catalyst core can be characterized using X-ray diffraction methods as shown in FIG. 1.

In another aspect of the invention, a method of dry reforming methane using the catalyst of the present invention includes contacting a reactant gas stream that includes CH₄ and CO₂ with any of the supported nanoparticle catalysts described throughout the specification under conditions sufficient to produce a product gas stream comprising H₂ and CO. In other aspects the can be used to in a steam reforming methane reaction. During the reforming, coke formation on the supported nanoparticle catalyst is substantially or completely inhibited. The reaction conditions can include a temperature of about 700° C. to about 950° C., a pressure of about 0.1 MPa to 2.5 MPa, and a gas hourly space velocity (GHSV) ranging from about 500 to about 100,000 h⁻¹.

Methods of making the nanoparticle catalysts of the present invention are also described. In one method, a mixture that includes precursors of the catalytic metals (e.g., M¹ precursor compound, a M² precursor compound, a M³ precursor compound) and a support material can be obtained. The M¹ and M² can be a metal nitrate, a metal amine, a metal chloride, a metal coordination complex, a metal sulfate, a metal phosphate hydrate, or any combination thereof. The M³ precursor compound can be a metal chloride, a metal sulfate, or metal nitrate, or a metal complex). The mixture can be obtained by mixing the three catalytic metals together in an aqueous composition, adding the support material to the aqueous composition, and then heating the mixture for 25 to 95 minutes at a temperature of 75 to 110° C. (e.g., under reflux). In some aspects, the support material is pre-calcined prior to its addition to the mixture. The aqueous composition can include an impregnation aid (e.g., a urea compound, a urea-succinic acid, an amino acid, or hexamethylenetetramine). A reducing agent (e.g., ethylene glycol, sodium borohydride, hydrazine, formaldehyde, an alcohol, hydrogen gas, carbon monoxide gas, oxalic acid, ascorbic acid, tris(2-carboxyethyl)phosphine HCl, lithium aluminum hydride, a sulfite, or any combination thereof) can be added to the mixture and the mixture can be heated (e.g., 125° C. to 175° C. for 2 to 4 hours) until the catalytic metal precursor compounds are reduced to a lower oxidation state (e.g., to their catalytic metal state). Without wishing to be bound by theory, it is believed that the reducing agent and conditions can assist in tuning the particle structure, the size, and the dispersion of the metals in the support. The reduced catalytic metal/support mixture can then be calcined at a temperature of 350° C. to 450° C. to form the supported nanoparticle catalyst where the catalytic metals are dispersed throughout the support. The supported nanoparticle catalyst can have an average particle size of about 1 to 100 nm, preferably 1 to 30 nm, more preferably 1 to 15 nm, most preferably ≦10 nm, with a size distribution having a standard deviation of ±20%.

In another aspect of the present invention, the catalyst of the present invention can also be made by making a calcined catalyst particle that includes M¹ and M² dispersed in the support material using the method previously described for dispersion of three catalytic metals, and then dispersing the noble metal (M³) on the surface of the particle. The calcined catalyst particle includes two metals dispersed in the support. The calcined catalyst particle can then be mixed with a M³ precursor compound under reducing conditions to form a M³ catalytic metal that is dispersed on the surface of the particle. Without wishing to be bound by theory, it is believed that the size believed that the use of reducing agents during dispersion of the metals can control the particle structure, the size and the dispersion of the M¹ and M² metals in the support and that the particle structure, the size and the dispersion of the M³ metal on the surface of the support. The average particle size of the supported nanoparticle catalyst is about 1 to 100 nm, preferably 1 to 30 nm, more preferably 1 to 15 nm, most preferably <10 nm, with a size distribution having a standard deviation of ±20%.

The term “about” or “approximately” are defined as being close to as understood by one of ordinary skill in the art, and in one non-limiting embodiment the terms are defined to be within 10%, preferably within 5%, more preferably within 1%, and most preferably within 0.5%.

The term “substantially” and its variations are defined as being largely but not necessarily wholly what is specified as understood by one of ordinary skill in the art, and in one non-limiting embodiment substantially refers to ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The catalysts of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the catalysts of the present invention are their abilities to catalyze reforming of methane, particularly dry reforming of methane.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 shows the XRD patterns of ZrO₂ support material (pattern (a)), supported bimetallic nanoparticles (patterns (b)-(d)), and the catalysts of the present invention (patterns (e) and (f)).

FIG. 1A is a blown-up comparison of the XRD patterns of the ZrO₂ support material pattern (a) and catalyst pattern (f) of the present invention.

FIG. 2 shows TPR profile for the Ni/ZrO₂, NiCo/ZrO₂ Pt—NiCo/ZrO₂, and Co/ZrO₂.

FIG. 3A shows the STEM and EDX of supported nanoparticle B.

FIG. 3B shows the STEM EDX of supported nanoparticle C.

FIG. 4A shows the H₂/CO ratio, CO₂ conversion, and CH₄ conversion for supported nanoparticle B in the dry reforming of methane reaction.

FIG. 4B shows the H₂/CO ratio, CO₂ conversion, and CH₄ conversion for Catalyst 3 in the dry reforming of methane reaction.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

The currently available catalysts used to reform hydrocarbons into syngas are prone to sintering and coking, which can lead to inefficient catalyst performance and ultimately failure of the catalyst after relatively short periods of use. This can lead to inefficient syngas production as well as increased costs associated with its production. A discovery has been made that avoids the sintering and coking issues. The discovery is based on the use of supported nanoparticle catalyst having at least two catalytic metals homogenously dispersed throughout the support material. A third catalytic metal can be homogeneously dispersed throughout the support material or dispersed on the surface of the nanoparticle catalyst. Without wishing to be bound by theory, it is believed that the synthesis method using reducing agents to control the particle size of the catalytic metals dispersed in or on the support produces nanoparticles having an average particle size of ≦10 nm, with a size distribution having a standard deviation of ±20%. Such a nanoparticle catalyst can reduce or prevent agglomeration of the catalytic material, thereby reducing or preventing sintering of the materials and inhibit coke formation on the surface of the catalyst.

These and other non-limiting aspects of the present invention are discussed in further detail in the following sections.

### A. Catalysts

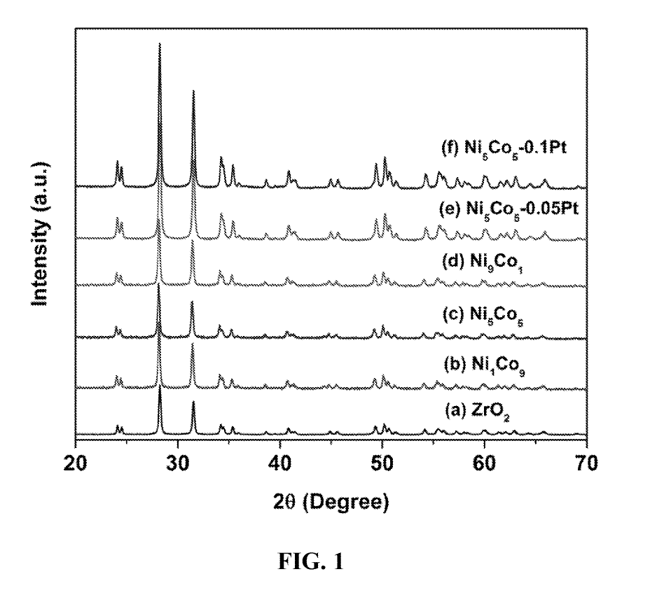

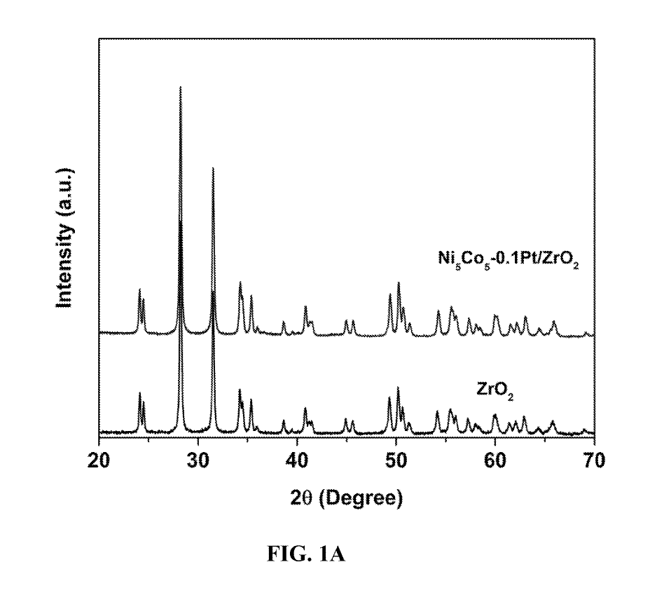

The supported nanoparticle catalyst can include at least two catalytic transition metals (M¹ and M²) and a noble metal (M³) of the Periodic Table. The metals can be individual particles or a mixture of metal particles bonded together (e.g., an alloy). For example, M¹ and M² or M¹, M² and M³ can be mixture of metals bonded together (e.g. an alloy, M¹M² and M¹M²M³) that are dispersed throughout the support material. In other aspects, M¹ and M² are dispersed throughout the support and M³ is dispersed on the surface of the nanoparticle. Non-limiting examples of such catalysts include NiCoPt, NiCoRh, FeCoPt, and FeCoRh on a support, or NiCoPt/Al₂O₃, FeCoPt/ZrO₂, FeCoPt/Al₂O₃, and FeCoRh/ZrO₂. In a preferred embodiment, the catalyst is NiCoPt in combination with a ZrO₂ support material. As shown in the Examples, the metal particles distributed throughout the support can be of a size and have a particle distribution such that the metals cannot be detected by X-ray diffraction (See, for example, FIG. 1). The nanoparticle catalyst can have an average particle size of about 1 to 100 nm, 1 to 30 nm, 1 to 15 nm, ≦10 nm, 2 to 8, 3 to 5 nm, or 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or any value there between. A size distribution of the particles can be narrow. In some embodiments, the particle size distribution has a standard deviation of ±10% to ±30%, or ±20%. The supported catalyst can be spherical or substantially spherical.

1. Metals

The catalyst can include at least three catalytic metals (e.g., M¹, M², and M³). M¹ and M² are different transition metals and M³ is a noble metal. Non-limiting examples of transition metals include nickel (Ni), cobalt (Co), manganese (Mn), iron (Fe), copper (Cu) or zinc (Zn). Non-limiting examples of noble metals include platinum (Pt), rhodium (Rh), ruthenium (Ru), iridium (Ir), silver (Ag), gold (Au) or palladium (Pd). In some embodiments, the catalyst includes 3, 4, 5, 6, or more transition metals and/or 2, 3, 4 or more noble metals. The metals can be obtained from metal precursor compounds. For example, the metals can be obtained as a metal nitrate, a metal amine, a metal chloride, a metal coordination complex, a metal sulfate, a metal phosphate hydrate, metal complex, or any combination thereof. Examples of metal precursor compounds include, nickel nitrate hexahydrate, nickel chloride, cobalt nitrate hexahydrate, cobalt chloride hexahydrate, cobalt sulfate heptahydrate, cobalt phosphate hydrate, platinum (IV) chloride, ammonium hexachloroplatinate (IV), sodium hexachloroplatinate (IV) hexahydrate, potassium hexachloroplatinate (IV), or chloroplatinic acid hexahydrate. These metals or metal compounds can be purchased from any chemical supplier such as Sigma-Aldrich (St. Louis, Mo., USA), Alfa-Aeaser (Ward Hill, Mass., USA), Strem Chemicals (Newburyport, Mass., USA).

The amount of catalytic metal on the support material depends, inter alia, on the catalytic activity of the catalyst. In some embodiments, the amount of catalyst present on the support ranges from 0.01 to 100 parts by weight of catalyst per 100 parts by weight of support, from 0.01 to 5 parts by weight of catalyst per 100 parts by weight of support. The molar percentage of M¹ can be 25 to 75 molar % of the total moles of catalytic metals (M¹, M²,M³) in the nanoparticle catalyst, or 30 to 70 molar %, 40 to 65 molar %, or 50 to 60 molar %, or 25, 30, 35, 40, 45, 50, 55, 60, 65, 70, 75 molar % of the total moles of catalytic metals in the nanoparticle catalyst. Similarly, a molar percentage of M² can be 25 to 75 molar % of the total moles of catalytic metals (M¹,M²,M³) in the nanoparticle catalyst, or 30 to 70 molar %, 40 to 65 molar %, or 50 to 60 molar %, or 25, 30, 35, 40, 45, 50, 55, 60, 65, 70, 75 molar % of the total moles of catalytic metals in the nanoparticle catalyst. A molar percentage of M³ can be 0.01 to 0.2 molar % of the total moles of catalytic metals (M¹,M²,M³) or 0.01 to 0.15, or 0.05 to 0.1, or 0.0001, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2 or any value there between molar % of the total moles of catalytic metals in the nano particle catalyst. A molar ratio of M¹ to M² can range from 1:9, 1:1, 9:1. A molar ratio of M³ to M² can be 0.05 to 0.1. In a particular embodiment, a molar ratio of M¹ to M² can be 1:1, with a M³ to M² ratio of 0.05 to 0.1.

2. Support

The support material or a carrier can be porous and have a high surface area. In some embodiments, the support is active (i.e., has catalytic activity). In other aspects, the support is inactive (i.e., non-catalytic). The support can be an inorganic oxide, a mixed metal oxide, a metal sulfide, a chalcogenide, an oxide of spinel, an oxide of wuestite structure (FeO), an oxide of olivine clay, an oxide of perovskite, a zeolite, carbon black, graphitic carbon, or a carbon nitride. Non-limiting examples of inorganic oxides or mixed metal oxides include zirconium oxide (ZrO₂), zinc oxide (ZnO), alpha, beta or theta alumina (Al₂O₃), activated Al₂O₃, cerium oxide (CeO₂), titanium dioxide (TiO₂), magnesium aluminum oxide (MgAlO₄), silicon dioxide (SiO₂), magnesium oxide (MgO), calcium oxide (CaO), barium oxide (BaO), strontium oxide (SrO), vanadium oxide (V₂O₅), chromium oxide (Cr₂O₃), niobium oxide (Nb₂O₅), tungsten oxide (WO₃), or combinations thereof.

### B. Preparation of the Supported Nanoparticle Catalysts

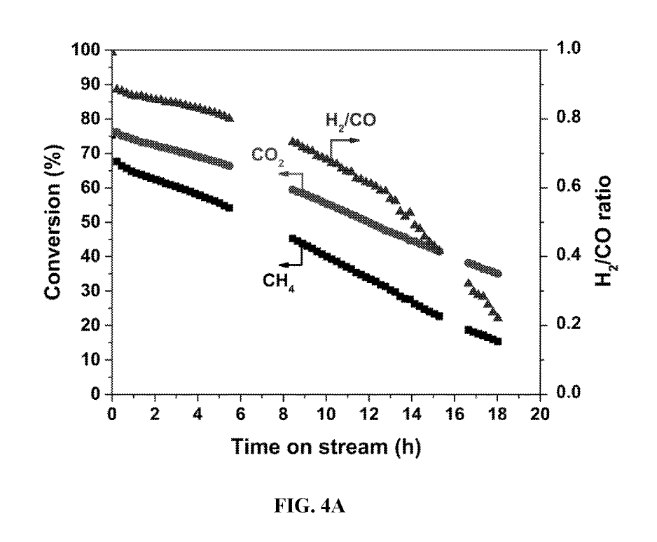

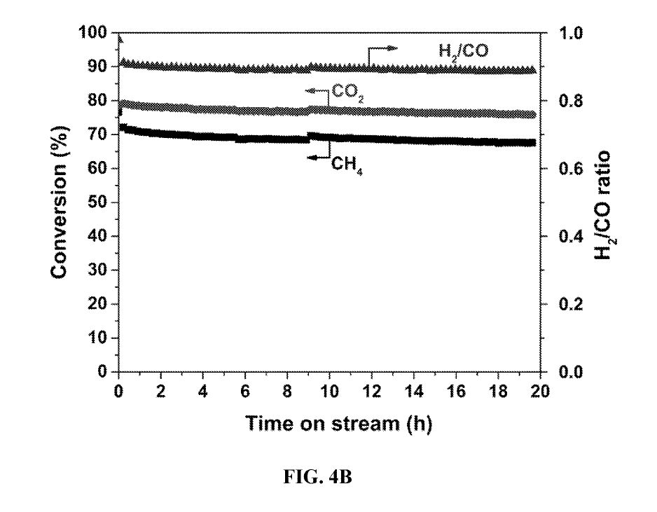

As illustrated in the Examples section, the produced nanoparticle catalysts of the invention are sinter and coke resistant materials at elevated temperatures (See, for example, FIG. 4B), such as those typically used in syngas production or methane reformation reactions (e.g., 700° C. to 950° C. or a range from 725° C., 750° C., 775° C., 800° C., 900° C., to 950° C.). Further, the produced catalysts can be used effectively in carbon dioxide reforming of methane reactions at a temperature range from 700° C. to 950° C. or from 800° C. to 900° C., a pressure range of 1 bara (0.1 MPa), and/or at a gas hourly space velocity (GHSV) range from 500 to 10000 h⁻¹.

The methods used to prepare the supported nanoparticle catalysts can control or tune the size of the catalytic metal particles and homogeneous dispersion of the catalytic metal particles in the support or on the surface of the support. In a preferred embodiment, the catalysts are prepared using incipient impregnation methods.

In one embodiment, a method that is used to prepare a nanoparticle catalyst includes obtaining a mixture of a M¹ precursor compound, a M² precursor compound, a M³ precursor compound and a support material. The mixture can be made as described throughout the specification (e.g., Examples 1 and 2). A non-limiting example of obtaining the mixture includes mixing a M¹ precursor compound (e.g., nickel (II) chloride hexahydrate), a M² precursor compound (e.g., cobalt (II) chloride hexahydrate), a M³ precursor (e.g., chloroplatinic acid hexahydrate) and an impregnation aid (e.g., urea, urea compound, a urea-succinic acid, an amino acid, or hexamethylenetetramine or any combination thereof) in water to form a mixture of metal hydroxide nanoparticles. The amount of the impregnation additive used can vary depending upon the other compounds and their relative amount, the desired characteristics of the product, and the like. The amount of impregnation aid can be 10 to 50 molar % based on the total molar percentage of catalytic metals. The components can be mixed sequentially in any order, mixed together at the same time, or a combination mixing together and sequentially. The mixture is kept under sufficient agitation at about room temperature for about 15 to 45 minutes. The metal hydroxide nanoparticle mixture can be mixed with a support material (e.g., a ZrO₂ material) to form a metal precursor/support mixture. The support material can be pre-calcined at about 800-900° C. for about 6 to 18 hours.

The metal precursor/support mixture can be heated under reflux at about 80-100° C. for about 30 minutes to 90 minutes. The amount of the support material used can vary depending upon the other compounds and their relative amount, the desired characteristics of the product, and the like, but in general, the loading of catalytic metals on the support material on can be about 0.01 to 5 wt. %, or 0.02, 0.05, 0.1, 0.5, 1.0, 1.5, 2.0, 2.5, 3.0, 3.5, 4.0, 4.5, 5 wt. % or any value there between. Subsequently, a reducing agent can be added to the metal precursor/support mixture after cooling down. In addition to changing the oxidation state of the metal precursor, the reducing agent can be used to control or tune the particle structure and size and the dispersion of the particles to desired dimensions (e.g., particles having an average particle size of ≦10 and a narrow particle distribution). In an embodiment, the reducing agent can be selected from ethylene glycol, sodium borohydride, hydrazine and its derivatives, and a combination thereof. The addition of ethylene glycol can provide partial control over the particle size and dispersion of the supported metal nanoparticles due to its rapid and homogeneous in situ generation of reducing species (e.g., the polyol process), thereby, resulting in more uniform metal deposition on the support. The amount of the reducing agent used can vary depending upon the specific polyol, the other compounds and their relative amount, the desired characteristics of the product, and the like, but in general, the amount of reducing agent (e.g., ethylene glycol) used can be about 100 ml to 250 ml. This mixture can heated to about 125 to 175° C. and kept for about 2 to 4 hours to achieve metal reduction. After filtering, the material can be washed and rinsed using water and alcohol (e.g., ethanol) and dried at desired temperature and time (e.g., overnight at 60 to 100° C.). The reduced metal mixture can be heated in the presence of flowing air at a temperature of about 350 to 450° C. (e.g., calcined) to form the supported catalytic metal nanoparticle catalyst. In a preferred embodiment, the catalyst is NiCoPt/ZrO₂.

In another embodiment, the method includes making a supported catalytic metal nanoparticle catalyst that has M³ dispersed on the surface of the particle. Similar to the method described above a mixture of a M¹ precursor compound, a M² precursor compound, a M³ precursor compound and a support material. A non-limiting example of obtaining the mixture includes mixing a M¹ precursor compound (e.g., nickel (II) chloride hexahydrate), a M² precursor compound (e.g., cobalt (II) chloride hexahydrate), and the impregnation aid (e.g., urea, urea compound, a urea-succinic acid, an amino acid, or hexamethylenetetramine or any combination thereof) in water to form a mixture of metal hydroxide nanoparticles. The amount of the impregnation additive used can vary depending upon the other compounds and their relative amount, the desired characteristics of the product, and the like. The amount of impregnation aid can be 10 to 50 molar %, 15 to 40 molar %, 20 to 30 molar %, based on the total molar percentage of catalytic metals. The components can be mixed sequentially in any order, mixed together at the same time, or a combination mixing together and sequentially. The mixture is kept under sufficient agitation at about room temperature for a period of time (e.g., about 15 to 45 minutes). The metal hydroxide nanoparticle mixture can be mixed with a support material (e.g., a ZrO₂ material) to form a metal precursor/support mixture. The support material can be pre-calcined at about 800-900° C. for about 6 to 18 hours prior to its addition to the mixture. The metal precursor/support mixture can be heated under reflux at about 80-100° C. for a desired amount of time (e.g., about 30 minutes to 90 minutes). The amount of the support material used can vary depending upon the other compounds and their relative amount, the desired characteristics of the product, and the like, but in general, the loading of catalytic metals on the support material on can be about 0.01 to 5 wt. %, or 0.02, 0.05, 0.1, 0.5, 1.0, 1.5, 2.0, 2.5, 3.0, 3.5, 4.0, 4.5, 5 wt. % or any value there between. Subsequently, a reducing agent can be added to the metal precursor/support mixture after cooling down. In addition to changing the oxidation state of the metal precursor, the reducing agent (e.g., ethylene glycol, sodium borohydride, hydrazine and its derivatives, and a combination thereof) can be used to control or tune the particle structure and size and the dispersion of the particles to desired dimensions. The amount of the reducing agent used can vary depending upon the specific polyol, the other compounds and their relative amount, the desired characteristics of the product, and the like, but in general, the amount of reducing agent (e.g., ethylene glycol) used can be about 100 ml to 250 ml. This mixture can heated to about 125 to 175° C. and kept for a period of time (e.g., about 2 to 4 hours) to achieve metal reduction. After filtering, the material can be washed and rinsed using water and alcohol (e.g., ethanol) and dried at desired temperature and time (e.g., overnight at 60 to 100° C.). The reduced metal mixture can be heated in the presence of flowing air at a temperature of about 350 to 450° C. (e.g., calcined) to form a supported catalytic metal (NiCo/ZrO₂) nanoparticle. Subsequently, the supported catalytic nanoparticle can be mixed with a Pt precursor compound under a reducing atmosphere (e.g., a hydrogen atmosphere) at a temperature of about 90 to 100° C. for a desired time frame (e.g., 15 to 30 min) to form a supported catalytic metal nanoparticle catalyst having two catalytic metals dispersed throughout the support material and a third catalytic metal dispersed on the surface of the particle.

### C. Carbon Dioxide Reforming of Methane

Also disclosed is a method of producing hydrogen and carbon monoxide from methane and carbon dioxide. While reforming of methane under dry (e.g., CO₂) conditions, it should be understood that the catalyst of the present invention can also be used for steam reforming of methane or partial oxidation of methane reactions. The method includes contacting a reactant gas mixture of a hydrocarbon and oxidant with any one of the supported nanoparticle catalysts discussed above and/or throughout this specification under sufficient conditions to produce hydrogen and carbon monoxide at a ratio of 0.35 or greater, from 0.35 to 0.95, or from 0.6 to 0.9. Such conditions sufficient to produce the gaseous mixture can include a temperature range of 700° C. to 950° C. or a range from 725° C., 750° C., 775° C., 800° C., to 900° C., or from 700° C. to 950° C. or from 750° C. to 900° C., a pressure range of about 1 bara, and/or a gas hourly space velocity (GHSV) ranging from 1,000 to 100,000 h⁻¹.

In particular instances, the hydrocarbon includes methane and the oxidant is carbon dioxide. In other aspects, the oxidant is a mixture of carbon dioxide and oxygen. In certain aspects, the carbon formation or coking is reduced or does not occur on the supported nanoparticle catalyst and/or sintering is reduced or does not occur on the supported nanoparticle catalyst. In particular instances, carbon formation or coking and/or sintering is reduced or does not occur when the supported nanoparticle catalyst is subjected to temperatures at a range of greater than 700° C. or 800° C. or a range from 725° C., 750° C., 775° C., 800° C., 900° C., to 950° C. In particular instances, the range can be from 700° C. to 950° C. or from 750° C. to 900° C.

In instances when the produced catalytic material is used in dry reforming methane reactions, the carbon dioxide in the gaseous feed mixture can be obtained from various sources. In one non-limiting instance, the carbon dioxide can be obtained from a waste or recycle gas stream (e.g. from a plant on the same site, like for example from ammonia synthesis) or after recovering the carbon dioxide from a gas stream. A benefit of recycling such carbon dioxide as starting material in the process of the invention is that it can reduce the amount of carbon dioxide emitted to the atmosphere (e.g., from a chemical production site). The hydrogen in the feed may also originate from various sources, including streams coming from other chemical processes, like ethane cracking, methanol synthesis, or conversion of methane to aromatics. The gaseous feed mixture comprising carbon dioxide and hydrogen used in the process of the invention may further contain other gases, provided that these do not negatively affect the reaction. Examples of such other gases include oxygen and nitrogen. The gaseous feed mixture has is substantially devoid of water or steam. In a particular aspect of the invention the gaseous feed contains 0.1 wt. % or less of water, or 0.0001 wt. % to 0.1 wt. % water. The hydrocarbon material used in the reaction can be methane. The resulting syngas can then be used in additional downstream reaction schemes to create additional products. Such examples include chemical products such as methanol production, olefin synthesis (e.g., via Fischer-Tropsch reaction), aromatics production, carbonylation of methanol, carbonylation of olefins, the reduction of iron oxide in steel production, etc.

The reactant gas mixture can include natural gas, liquefied petroleum gas comprising C₂-C₅ hydrocarbons, C₆+ heavy hydrocarbons (e.g., C₆ to C₂₄ hydrocarbons such as diesel fuel, jet fuel, gasoline, tars, kerosene, etc.), oxygenated hydrocarbons, and/or biodiesel, alcohols, or dimethyl ether. In particular instances, the reactant gas mixture has an overall oxygen to carbon atomic ratio equal to or greater than 0.9.

The method can further include isolating and/or storing the produced gaseous mixture. The method can also include separating hydrogen from the produced gaseous mixture (such as by passing the produced gaseous mixture through a hydrogen selective membrane to produce a hydrogen permeate). The method can include separating carbon monoxide from the produced gaseous mixture (such as passing the produced gaseous mixture through a carbon monoxide selective membrane to produce a carbon monoxide permeate).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

All materials for were obtained from Sigma Aldrich® Chemical Company (USA) unless otherwise specified. ZrO₂ (specific surface area 70 m²g⁻¹) was purchased from DAIICHI KIGENSO KAGAKU KOGYO CO., LTD. Prior to use ZrO₂ was pre-heated at 850° C. for 12 h to obtain ZrO₂ with a specific surface area 6 m²g⁻¹. The CO₂ (99.9999%), methane (99.999%) and hydrogen (99.9995%) gases were purchased from Abdullah Hashim Industrial Gases & Equipment Co. Ltd. (Jeddah) and used as received.

### Example 1

### Synthesis of Supported M¹ and M² Bimetallic Nanoparticles Having and M² Dispersed Throughout the Support

Bimetallic Nanoparticle B. Urea (≧99.5% purity, 2.50 g, 41.6 mmol) was dissolved in ultra-pure water (100 ml). Under controlled atmosphere, an aqueous solution of nickel (II) chloride hexahydrate (NiCl₂.6H₂O 99.999% purity, 0.05 g, 0.2 mmol) and Cobalt (II) chloride hexahydrate (CoCl₂.6H₂O, 0.05 g, 0.21 mmol) was added, and the mixture was stirred at room temperature for 30 minutes. Calcined ZrO₂ (500 mg) was added under rapid stirring (600 rpm), and the mixture was heated up to 90° C. and kept for 1 h and then cooled to room temperature. Ethylene glycol (100 ml) was added to the cooled mixture, and then heated to 150° C. and kept for 3 h. After filtering the mixture, washing the comparative catalyst with 600 ml distilled water and 100 ml ethanol, the bimetallic nanoparticle B was dried overnight at 70° C. Bimetallic nanoparticles A and C were prepared in a similar manner using the molar % listed in Table 1.

TABLE 1

| Supported | Ni | Co |
|---|---|---|
| Nanoparticle | (molar %) | (molar %) |
| A | 10 | 90 |
| B | 50 | 50 |
| C | 90 | 10 |

### Example 2

### Synthesis of Supported M¹, M², and M³ Nanoparticle Catalysts Having and M² Dispersed Throughout the Support

Catalysts D and E. Supported nanoparticle B was co-impregnated with an aqueous solution of chloroplatinic acid hexahydrate (≧37.50% Pt basis, H₂PtCl₆.6H₂O) at the molar ratios listed in Table 2. The NiCo was set to 5 wt % for Pt-NiCo/ZrO₂ (Pt/Co=0.05 or 0.1 in molar ratio). The samples were dried at 100° C. overnight, followed by calcination at 400° C. in flowing air to obtain the nanoparticle catalysts of the present invention with a platinum particles dispersed on the bimetallic nanoparticle surface.

TABLE 2

| | Ni | Co | Pt/Co |
|---|---|---|---|
| Catalyst | (mol %) | (mol %) | (molar ratio) |
| D | 50 | 50 | 0.05 |
| E | 50 | 50 | 0.1 |

### Example 3

### Prophetic Synthesis of Supported M¹, M², and M³ Nanoparticle Catalysts Having and M² Dispersed Throughout the Support

Catalyst F. Using a surface organometallic chemistry (SOMC) method Pt could be selectively deposited on the surface of NiCo nanoparticle (e.g., supported nanoparticle B) as follows: NiCo/ZrO₂ (1.0 g) can be treated at 450° C. for 3.0 h in a hydrogen flow (300 ml/min) and cooled down to room temperature in a hydrogen atmosphere. The powder can be transferred into a 100-mL Schlenk flask under hydrogen protection. Toluene solution (40 ml) of a given amount of Pt(acac)₂ can be added, and the mixture can be stirred at room temperature for 20 h under hydrogen (1 atm). After filtering, washing with toluene (3×30 ml) inside the glovebox, and drying under vacuum, the nanoparticle catalyst can be obtained as powder.

### Example 4

### Prophetic Synthesis of Supported M¹, M², and M³ Nanoparticle Catalysts Having M¹, M² and M² Dispersed Throughout the Support

Catalyst G. A specific amount of urea can be dissolved in ultra-pure water (100 ml). Under controlled atmosphere, the metal salts solution of Ni, Co and Pt can be added. Zirconium oxide (500 mg) can be added under rapid stirring (600 rpm). After that, the mixture can be heated to 90° C. and kept for 1 h. The mixture can be cooled to room temperature and 100 ml ethylene glycol can be added, heated to 150° C. and kept for 3 h. The catalyst can be filtered, washed with distilled water (600 ml) and ethanol (100 ml) and dried overnight at 70° C.

### Example 5

### Characterization of the Bimetallic Particle and the Catalyst of the Present Invention

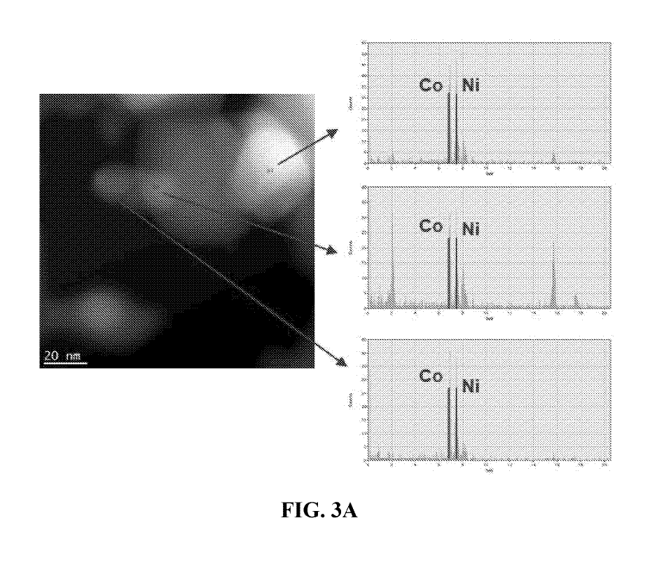

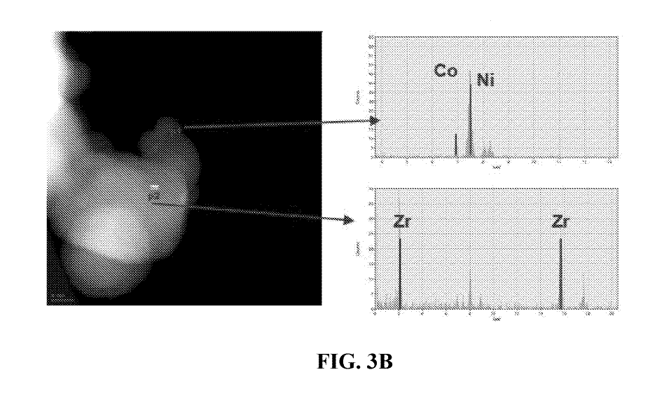

Elemental analysis. Elemental analysis was performed in a Flask 2000 Thermo Scientific CHNS/O analyzer on supported nanoparticle B. NiCo loading was 5 wt % and that the Ni:Co was in a stoichiometric ratio of 2.1:2.1 wt % on the catalyst as determined by elemental analysis. The stoichiometric ratio was also confirmed by EDX (See, for example, FIG. 3).

X-ray diffraction (XRD) analysis. Supported nanoparticles A to C that contained M¹ and M² metals and catalysts D and E were characterized by XRD after the metals in the nanoparticles were reduce to their metallic state by subjecting them to a 1 h heat treatment under H₂ flow at 700° C. FIG. 1 shows the XRD patterns results for the ZrO₂ support material, supported nanoparticles A-C, and catalysts D and E of the present invention. Pattern (a) is the ZrO₂ support material, pattern (b) is supported nanoparticle A, pattern (c) is supported nanoparticle B, pattern (d) is supported nanoparticle C, pattern (e) is the supported catalyst D, and pattern (f) is the supported catalyst E. FIG. 1A is the XRD Pattern of the ZrO₂ support and the supported catalyst D. The XRD patterns for the supported nanoparticles A-C (5 wt % NiCo) and the catalysts D and E showed no peaks that related to the supported Ni or Co metals after the reduction at 700° C. The only peaks observed corresponded to the zirconia support. This is an indication of the homogeneously distributed M¹ and M² metals (e.g., NiCo) in the support in the nanoparticles and the catalysts.

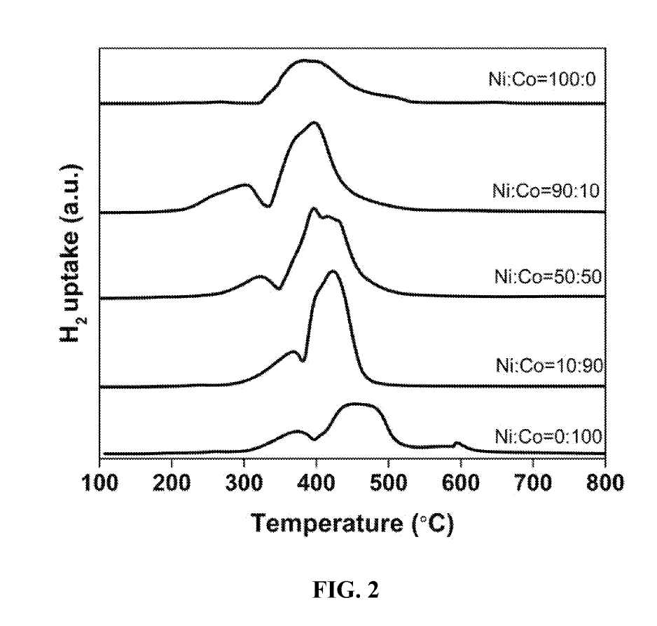

Temperature-programmed reduction (TPR) analysis. TPR measurements were operated over 0.1 g of the supported nanoparticle B and catalyst D held between quarts wool plugs in a tubular quarts reactor. The temperature was increased from room temperature to 750° C., at a rate of 10° C. min⁻¹ in flowing H₂/Ar gas (5/95 vol./vol. mixture with a total flow of 30 ml·min⁻¹. The hydrogen consumption was monitored with thermal conductivity detector (TCD).) FIG. 2 shows TPR profile for the Ni/ZrO₂, NiCo/ZrO₂ (supported nanoparticle B), Pt—NiCo/ZrO₂ (Pt/Co=0.05 molar ratio, Catalyst D), and Co/ZrO₂. The peaks for Catalyst D were observed to start at lower temperature of 160° C. and end at 350° C. as compared to supported mono-metal compounds and supported nanoparticle B. This lower temperature correlates to the reduction temperature of the metals. Without wishing to be bound by theory, it is believed that this lower temperature (at which the reduction of the nickel oxide and cobalt oxides dispersed in the support occurred) was due to the presence of Pt.

High-angle annular dark-field scanning transmission electron microscopy (HAADF-STEM) and energy-dispersive X-ray spectroscopy (EDX) analysis. HAADF-STEM and EDX measurements were performed on a Titan G2 60-300 CT electron microscope by operating it at the accelerating voltage of 300 kV. The samples were prepared by depositing a drop of dilute sample solution on a carbon-coated copper grid and dried at room temperature. The morphologies of supported nanoparticles B and C were investigated by STEM as shown in FIGS. 3A and 3B. FIG. 3A shows the STEM and EDX of supported nanoparticle B and FIG. 3B shows the STEM EDX of supported nanoparticle C. It was confirmed by EDX that each particle had the same composition ratio of both metals. In the case of supported nanoparticle B, it was observed by EDX that three different particles had the same composition of Ni:Co, thereby confirming the homogeneous deposition-precipitation (HDP) method of Example 1 homogeneously dispersed the metal alloy in the support.

### Example 6

### Dry Reforming of Methane

Supported nanoparticle B and Catalyst E (“samples”) were used to produce hydrogen and carbon monoxide from methane and carbon dioxide. The samples (50 mg) were ground into powders and pressed into pellets for 5 min. The pellets were crushed and sieved to obtain grains with diameters between 250-300 microns, which then were introduced into a quartz reactor. The reactor was mounted in the dry reforming of methane set-up. The sample was heated up to 750° C. (heating rate, 10° C./min) under H₂/Ar flow (H₂, 10 vol. %; 40 ml/min) and kept at 750° C. for 1 h. The reactant gases (CH₄/CO₂/N₂ ratio of 1/1/8, and pressure (P) of 1 atm) were introduced to the reactor at a total flow of 100 ml/min (WHSV=120 L·h⁻¹·g cat⁻¹). Reactants and products were continuously monitored using an on-line gas chromatography. The amount of coke deposited on the samples was quantified by temperature-programmed oxidation (TPO) with O₂/He. For that, the sample was transferred to a tubular quarts reactor then heated up to 800° C. with a heating rate of 10° C. min⁻¹. The deposited carbon was oxidized to CO, which then converted to CH₄ by a methanizer, and this CH₄ was detected by a flame ionization detector (FID). FIG. 4A shows the H₂/CO ratio (data line H₂/CO), CO₂ conversion (data line CO₂), and CH₄ conversion (data line CH₄) for supported nanoparticle B in the dry reforming of methane reaction. FIG. 4B shows the H₂/CO ratio (data line H₂/CO), CO₂ conversion (data line CO₂), and CH₄ conversion (data line CH₄) for Catalyst D in the dry reforming of methane reaction. The activity of the supported NiCo/ZrO₂ was improved slightly by a small amount of Pt through 20 h as shown in FIGS. 4A and 4B. In addition, the amount of coke deposited on the catalyst was not significant (0.003 wt %) after 20 h of reaction for Catalyst E and the catalyst was not deactivated. Supported nanoparticle B deactivated after 15 hours on stream. From these results, it was concluded that deactivation of NiCo metals in the supported nanoparticle B was due to oxidation of the Co metal.

1. A supported nanoparticle catalyst capable of producing hydrogen (H₂) and carbon monoxide (CO) from methane (CH₄) and carbon dioxide (CO₂), the supported nanoparticle catalyst comprising catalytic metals M¹, M², M³, and a support material, wherein:
(a) a calcined particle includes M¹ and M² dispersed in the support material, wherein M¹ and M² are different and are each selected from nickel (Ni), cobalt (Co), manganese (Mn), iron (Fe), copper (Cu) or zinc (Zn); and
(b) M³ is dispersed on the surface of the calcined particle and is a noble metal, and wherein the nanoparticle catalyst has an average particle size of about 1 to 100 nm.

2. The supported nanoparticle catalyst of claim 1, wherein M¹ is 25 to 75 molar % of the total moles of catalytic metals (M¹,M²,M³), M² is 25 to 75 molar % of the total moles of catalytic metals (M¹,M²,M³), and M³ is 0.01 to 0.2 molar % of the total moles of catalytic metals (M¹,M²,M³).

3. The supported nanoparticle catalyst of claim 2, wherein the support material is 80 to 99.5 wt. % of supported nanoparticle catalyst.

4. The supported nanoparticle catalyst of claim 1 wherein the average particle size of the nanoparticle catalyst is 1 to 30 nm.

5. The supported nanoparticle catalyst of claim 1, wherein M¹ and M² are a metal alloy (M¹M²).

6. The supported nanoparticle catalyst of claim 5, wherein the metal alloy is dispersed in the support material.

7. The supported nanoparticle catalyst of claim 1, wherein the noble metal is platinum (Pt), rhodium (Rh), ruthenium (Ru), iridium (Ir), silver (Ag), gold (Au) or palladium (Pd).

8. (canceled)

9. The supported nanoparticle catalyst of claim 1, wherein the support material comprises a metal oxide, a mixed metal oxide, a metal sulfide, a chalcogenide, an oxide of spinel, an oxide of wuestite structure (FeO), an oxide of olivine clay, an oxide of perovskite, a zeolite, carbon black, graphitic carbon, or a carbon nitride.

10. The supported nanoparticle catalyst of claim 9, wherein the metal oxide comprises ZrO₂, ZnO, Al₂O₃, CeO₂, TiO₂, MgAl₂O₄, SiO₂, MgO, CaO, BaO, SrO, V₂O₅, Cr₂O₃, Nb₂O₅, WO₃, or any combination thereof.

11. The supported nanoparticle catalyst of claim 10, wherein M¹ is Ni, M² is Co, M³ is Pt, and the support is ZrO₂.

12. The supported nanoparticle catalyst of claim 11, wherein M¹ and M² are homogeneously dispersed throughout the support as characterized by a powder X-ray diffraction pattern as substantially depicted below in patterns (e) or (f).

[symbol]

13. A method of producing H₂ and CO comprising contacting a reactant gas stream that includes CH₄ and CO₂ with the supported nanoparticle catalyst of claim 1 under reaction conditions sufficient to produce a product gas stream comprising H₂ and CO, wherein the reaction conditions include a temperature of about 700° C. to about 950° C., a pressure of about 0.1 MPa to 2.5 MPa, and a gas hourly space velocity (GHSV) ranging from about 500 to about 100,000 h⁻¹.

14. The method of claim 13, wherein coke formation on the supported nanoparticle catalyst is substantially or completely inhibited.

15-25. (canceled)

26. A method of making the supported nanoparticle catalyst of claim 1, the method comprising:
(a) obtaining a mixture comprising a M¹ precursor compound, a M² precursor compound, and a support material;
(b) adding a reducing agent to the mixture and reducing the M¹ and M² precursor compounds to M¹ and M² catalytic metals;
(c) calcining the mixture to form a particle having M¹ and M² dispersed in the support material; and
(d) mixing a M³ precursor compound with the particle from step (c) under reducing conditions to form a M³ catalytic metal that is dispersed on the surface of the particle.

27. The method of claim 26, wherein obtaining the mixture in step (a) comprises:
mixing the M¹ and M² precursor compounds in an aqueous composition;
(ii) adding the support material to the aqueous composition; and
(iii) heating the aqueous composition from step (ii) for 25 to 95 minutes at a temperature of 75 to 110° C.

28. (canceled)

29. The method of claim 26, wherein the support material in step (ii) is pre-calcined.

30. The method of claim 26, wherein the aqueous composition comprises a urea compound, a urea-succinic acid, an amino acid, or hexamethylenetetramine.

31. The method of claim 26, wherein step (b) further comprises heating the mixture to 125° C. to 175° C. for 2 to 4 hours and step (c) comprises calcining the mixture at 350° C. to 450° C., and step (d) comprises mixing at a temperature of 70° C. to 75° C., under a hydrogen atmosphere.

32. (canceled)

33. (canceled)

34. The method of claim 26, wherein the M¹ and M² precursor compounds are each a metal nitrate, a metal amine, a metal chloride, a metal coordination complex, a metal sulfate, a metal phosphate hydrate, or combination thereof, and wherein the M³ precursor compound is a metal chloride, a metal sulfate, or metal nitrate, or a metal complex.

35. (canceled)

36. The method of claim 26, wherein the reducing agent is ethylene glycol, sodium borohydride, hydrazine, formaldehyde, an alcohol, hydrogen gas, carbon monoxide gas, oxalic acid, ascorbic acid, tris(2-carboxyethyl)phosphine HCl, lithium aluminum hydride, a sulfite, or any combination thereof.
